(19) United States
(12) Patent Application Publication
(10) Pub. No.: US 2018/0044542 A1
(43) Pub. Date: Feb. 15, 2018

(54) COMPOSITION OF HIGH FLAME RETARDING POLYURETHANE FOAM AND INSULATOR COMPRISING THE SAME

(71) Applicants: DONGSUNG FINETEC CO., Ltd., Anseong-si (KR); HYUNDAI HEAVY INDUSTRIES CO., Ltd., Ulsan (KR)

(72) Inventors: Jong Soek LEE, Anseong-si (KR); Hyeon Sung KIM, Cheonan-si (KR); Byung Hun Yu, Pyeongtaek-si (KR); Han Na CHA, Incheon (KR); Seung Gon Choo, Ulsan (KR); Han Jin Bae, Busan (KR); Eun Ha Song, Ulsan (KR)

(21) Appl. No.: 15/674,301

(22) Filed: Aug. 10, 2017

(30) Foreign Application Priority Data
Aug. 11, 2016 (KR) 10-2016-0102101

(51) Int. Cl. C09D 5/18; C08G 18/40; C08G 18/08; C08G 18/76; C08G 18/42; C08K 5/521; C08J 9/14; C09D 175/08; C09K 21/12; C08G 18/48

(52) U.S. Cl. CPC C09D 5/18; C09K 21/12; C08G 18/4018; C08G 18/14; C08G 18/4829; C08G 18/4208; C08K 5/521; C08J 9/147; C09D 175/08; C08G 18/7671; C08J 2207/04; C08J 2375/08; C08J 2203/182; C08J 2203/142; C08G 2150/60; C08G 2330/00

(57) ABSTRACT

Disclosed herein is a highly flame retardant polyurethane spray foam composition. The composition includes 100 parts by weight to 200 parts by weight an isocyanate compound relative to 100 parts by weight of a resin mixture including 46 wt % to 75 wt % of a polyol, 10 wt % to 30 wt % of a blowing agent, and 5 wt % to 30 wt % of an additive, wherein the polyol includes 1 wt % to 10 wt % of a polyether polyol and 45 wt % to 65 wt % of an aromatic polyester polyol, and the aromatic polyester polyol has an average hydroxyl value of 250 mgKOH/g to 380 mgKOH/g.

### CROSS-REFERENCE TO RELATED APPLICATION

This application claims priority under 35 U.S.C. 119(a) to Republic of Korea Patent Application No. 10-2016-0102101 filed on Aug. 11, 2016, which is incorporated by reference herein in its entirety.

### FIELD OF THE INVENTION

The present invention relates to a polyurethane spray foam composition and a heat insulator including the same.

### DESCRIPTION OF RELATED ART

Polyurethane spray foam exhibits excellent properties in terms of mechanical strength, dimensional stability, insulation performance and workability, and is widely used in shipbuilding and construction. Particularly, polyurethane spray foam is useful as a material for a building panel, a panel for a refrigeration warehouse, and an insulator for an LNG, LEG, or LPG tank.

Typical polyurethane spray foam is manufactured by a method in which polyether polyol, polyester polyol, a surfactant, a catalyst and a blowing agent (HFC or HCFC) are mixed, followed by mixing an isocyanate compound with the mixture to prepare a polyurethane foam composition, and then the composition is sprayed onto an adherend, such as a surface of an LNG, LEG, or LPG tank using a high-pressure sprayer.

However, typical polyurethane spray foam as disclosed in Korean Patent Publication No. 10-2011-0129429 (published on Dec. 1, 2011) is vulnerable to fire despite having good basic physical properties such as tensile strength and flexural strength.

Polyurethane foam has an isocyanate index of 1.5 or less, and polyisocyanurate foam has an isocyanate index of higher than 1.5. Herein, “isocyanate index” refers to a ratio of the equivalent amount of isocyanate used relative to the theoretical equivalent amount. Polyisocyanurate foam exhibits excellent flame retardancy and heat resistance and is produced into a desired product by a panel foaming or block foaming process.

Polyurethane spray foam has an isocyanate index of 1.5 or less and a density of 10 kg/m³ to 100 kg/m³ and is used in most shipbuilding plants and construction companies. However, since polyurethane spray foam is vulnerable to fire, there is a concern of loss of lives and properties.

In order to secure flame retardancy and heat resistance, various attempts have been made to form a polymeric coating, such as highly flame retardant urea, on the polyurethane spray foam. However, there is a problem in that such a polymeric coating is not thick enough to withstand strong flames.

Therefore, there is a need for a polyurethane spray foam having good flame retardancy and heat resistance.

### SUMMARY

It is one aspect of the present invention to provide a polyurethane spray foam which has improved flame retardancy while exhibiting good properties in terms of free foam density, thermal conductivity and compressive strength.

It is another aspect of the present invention to a provide polyurethane spray foam which has good in-situ workability.

It is a further aspect of the present invention to a provide polyurethane spray foam having good quality.

In accordance with one aspect of the present invention, a highly flame retardant polyurethane spray foam composition includes 100 parts by weight to 200 parts by weight an isocyanate compound relative to 100 parts by weight of a resin mixture including 46 wt % to 75 wt % of a polyol, 10 wt % to 30 wt % of a blowing agent, and 5 wt % to 30 wt % of an additive, wherein the polyol includes 1 wt % to 10 wt % of a polyether polyol and 45 wt % to 65 wt % of an aromatic polyester polyol, and the aromatic polyester polyol has an average hydroxyl value of 250 mgKOH/g to 380 mgKOH/g.

In accordance with another aspect of the present invention, a highly flame retardant polyurethane spray foam includes the highly flame retardant polyurethane spray foam composition as set forth above.

In accordance with a further aspect of the present invention, a heat insulator includes the highly flame retardant polyurethane spray foam as set forth above.

The polyurethane spray foam composition according to the present invention including the aforementioned components in specific amounts and having a particular average hydroxyl value of the aromatic polyester polyol can secure workability while providing good flame retardancy. Further, in the polyurethane spray foam composition, a mixture of at least two fluorine compounds having different boiling points is used as the blowing agent, thereby improving adhesion to an adherend, and a mixture of a non-silicone surfactant and a silicone surfactant is used as a surfactant, thereby improving quality of polyurethane spray foam formed using the foam composition.

### DETAILED DESCRIPTION

As a result of repeated experiments to solve the problem that typical spray foam is vulnerable to fire despite good basic physical properties such as compressive strength, tensile strength and flexural strength, the present inventors found that a polyurethane spray foam composition including the aforementioned components in specific amounts and having a particular average hydroxyl value of the aromatic polyester polyol could secure workability while providing good flame retardancy.

In addition, it was found that when a mixture of at least two fluorine compounds having different boiling points was used as the blowing agent in the spray foam composition, spray foam formed using the spray foam composition had improved adhesive strength and high workability.

Further, it was found that, when a mixture of a non-silicone surfactant and a silicone surfactant was used as the surfactant in the spray foam composition, spray foam formed using the spray foam composition could have good quality and high workability.

In accordance with one embodiment of the present invention, a highly flame-retardant polyurethane spray foam composition includes 100 parts by weight to 200 parts by weight of an isocyanate compound relative to 100 parts by weight of a resin mixture including 46 wt % to 75 wt % of a polyol, 10 wt % to 30 wt % by weight of a blowing agent, and 5 wt % to 30 wt % of an additive, wherein the polyol includes 1 wt % to 10 wt % of a polyether polyol and 45 wt % to 65 wt % of an aromatic polyester polyol, and the aromatic polyester polyol has an average hydroxyl value of 250 mgKOH/g to 380 mgKOH/g.

The polyether polyol may include a compound polymerized using an initiator having 3 to 7 hydroxyl groups per molecule.

The initiator may include at least one selected from the group consisting of sucrose, glycerine, toluenediamine, and ethylenediamine each having 3 to 6 hydroxyl groups per molecule.

The initiator may have a number average molecular weight of 100 g/mol to 2,000 g/mol.

The aromatic polyester polyol may include a compound prepared by polymerizing at least one selected from the group consisting of phthalic anhydride, terephthalic acid, adipic acid, ethylene glycol, and diethylene glycol.

The blowing agent may include a mixture or compound including at least two compounds, wherein the at least two compounds may include at least one selected from the group consisting of fluorine compounds having different boiling points and C₄ to C₁₀ cycloalkanes.

The fluorine compounds may include at least one selected from the group consisting of hydrochlorofluorocarbon (HCFC) compounds, hydrofluorocarbon (HFC) compounds, and hydrochlorofluoroolefin (HCFO) compounds.

The hydrochlorofluorocarbon (HCFC) compounds may include 1,1-dichloro-1-fluoroethane.

The hydrofluorocarbon (HFC) compounds may include at least one selected from the group consisting of 1,1,1,3,3-pentafluoropropane, 1,1,1,3,3-pentafluorobutane, and 1,1,1,2,3,3,3-heptafluoropropane.

The hydrochlorofluoroolefin (HCFO) compounds may include 1-chloro-3,3,3-trifluoropropylene.

The additive may include a non-silicone surfactant and a silicone surfactant.

The non-silicon surfactant may include alkoxy alcohol.

In accordance with another embodiment of the present invention, highly flame retardant polyurethane spray foam includes the highly flame retardant polyurethane spray foam composition.

In accordance with a further embodiment of the present invention, a heat insulator includes the highly flame retardant polyurethane spray foam.

One embodiment of the present invention relates to a highly flame-retardant polyurethane spray foam composition which includes 100 parts by weight to 200 parts by weight of an isocyanate compound relative to 100 parts by weight of a resin mixture including 46 wt % to 75 wt % of a polyol, 10 wt % to 30 wt % by weight of a blowing agent, and 5 wt % to 30 wt % of an additive, wherein the polyol includes 1 wt % to 10 wt % of a polyether polyol and 45 wt % to 65 wt % of an aromatic polyester polyol, and the aromatic polyester polyol has an average hydroxyl value of 250 mgKOH/g to 380 mgKOH/g.

A hydroxyl group of the aromatic polyester polyol undergoes polymerization with an isocyanate group (—N—C═O) of the isocyanate compound. When the average hydroxyl value of the aromatic polyester polyol is controlled within the range of 250 mg KOH/g to 380 mgKOH/g while controlling the amount of each component of the highly flame retardant polyurethane spray foam composition within the aforementioned range, spray foam formed of the composition can secure flame retardancy and good workability.

Herein, “workability” can be evaluated depending upon bubbling during spray foaming or post-foaming after completion of spray foaming. Here, less bubbling or post-foaming indicates better workability.

If the average hydroxyl value of the aromatic polyester polyol is less than 250 mgKOH/g, polyurethane foam prepared using the composition can have poor workability despite flame retardancy, whereas, if the average hydroxyl value of the aromatic polyester polyol exceeds 380 mgKOH/g, the prepared polyurethane foam can have poor flame retardancy.

The polyether polyol may include a compound polymerized using an initiator having 3 to 7 hydroxyl groups per molecule. Specifically, the initiator may include at least one selected from the group consisting of sucrose, glycerine, toluenediamine, and ethylenediamine each having 3 to 6 hydroxyl groups per molecule. More specifically, the initiator may have a number average molecular weight of 100 g/mol to 2,000 g/mol. Within these ranges of the number of hydroxyl groups per molecule and the number average molecular weight of the initiator, the spray foam composition can secure flame retardancy and workability without deterioration in moldability and physical strength.

For example, the polyether polyol may be prepared by polymerizing the initiator having 3 to 6 hydroxyl groups per molecule and a number average molecular weight of 100 g/mol to 2,000 g/mol with ethylene oxide, propylene oxide or a mixture thereof.

The aromatic polyester polyol may include a compound prepared by polymerizing at least one selected from the group consisting of phthalic anhydride, terephthalic acid, adipic acid, ethylene glycol, and diethylene glycol.

Specifically, the aromatic polyester polyol may include one or two of a polyol compounds obtained by reacting phthalic anhydride, terephthalic acid, and/or adipic acid with ethylene glycol and/or diethylene glycol.

The blowing agent serves to generate gas during polymerization to form foam cells inside a heat insulator. Since the blowing agent exists in the cells after formation of polyurethane foam, a material having low thermal conductivity and high stability may be used as the blowing agent. For example, water, carboxylic acid, a fluorine blowing agent, or an inert gas such as carbon dioxide or air may be used as the blowing agent.

For example, the blowing agent may include a mixture or compound including at least two compounds, wherein the at least two compounds may include at least one selected from the group consisting of fluorine compounds having different boiling points and C₄ to C₁₀ cycloalkanes. For example, the blowing agent may include at least two fluorine compounds having different boiling points or may include both at least two fluorine compounds having different boiling points and C₄ to C₁₀ cycloalkanes.

When the blowing agent includes the fluorine compounds having different boiling points and the C₄ to C₁₀ cycloalkanes, the composition can have good processability. Particularly, when a mixture of at least two fluorine compounds and/or the cycloalkanes is used as the blowing agent instead of using only one type of blowing agent, the foam can be continuously formed rather than formed only at a certain temperature. Further, this mixture can reduce internal heat generation such that cells of the polyurethane spray urethane foam can remain spherical during formation and growth thereof, thereby improving processability of the composition.

When the blowing agent includes the fluorine compounds having different boiling points and/or the C₄ to C₁₀ cycloalkanes, the composition can have good adhesive strength. Generally, the polyurethane spray foam is used as a heat insulator without using a separate adhesive. Thus, in manufacture of a heat insulator using polyurethane spray foam products, adhesive strength of the polyurethane foams to an adherend or adhesive strength between the polyurethane foam products has a great effect on performance of a heat insulator product. Here, the thickness of a skin of the polyurethane foam affects the adhesive strength of the polyurethane foam. Specifically, the adhesive strength of the polyurethane foam increases with decreasing thickness of the skin. Here, the lower the boiling point of the blowing agent, the thinner the skin and the better the adhesive strength. However, when the boiling point is excessively low, vapor pressure increases, making it difficult to pack the product. When the fluorine compounds having different boiling points are used alone or in combination with the C₄ to C₁₀ cycloalkanes, the composition can have good properties in terms of adhesive strength and processability. For example, each of the fluorine compounds may have a boiling point of 0° C. to 100° C., and a difference between boiling points of the fluorine compounds may range from 5° C. to 60° C.

As described above, the blowing agent used in the highly flame retardant polyurethane spray foam composition according to one embodiment of the present invention includes a mixture or compound including at least two compounds, wherein the at least two compounds include at least one selected from the group consisting of fluorine compounds having different boiling points and C₄ to C₁₀ cycloalkanes, such that the composition can have good processability and polyurethane spray foam products prepared using the composition can have good properties in terms of adhesion to an adherend or adhesion therebetween.

Specifically, the fluorine compounds may include at least one selected from the group consisting of hydrochlorofluorocarbon (HCFC) compounds, hydrofluorocarbon (HFC) compounds, and hydrochlorofluoroolefin (HCFO) compounds.

More specifically, the hydrochlorofluorocarbon (HCFC) compounds may include 1,1-dichloro-1-fluoroethane; the hydrofluorocarbon (HFC) compounds may include at least one selected from the group consisting of 1,1,1,3,3-pentafluoropropane, 1,1,1,3,3-pentafluorobutane, and 1,1,1,2,3,3,3-heptafluoropropane; and the hydrochlorofluoroolefin (HCFO) compounds may include 1-chloro-3,3,3-trifluoropropylene.

The additive may include a non-silicone surfactant and a silicone surfactant, wherein the non-silicon surfactant may include alkoxy alcohol, without being limited thereto.

The surfactant prevents cells formed in foam from being combined with one another or collapsing, improves compatibility between the components of the composition, and stabilizes and homogenizes the cells.

Generally, a polyurethane heat insulator for gas tanks or the like includes a protective polymeric coating on polyurethane foam. Here, surface roughness of the polyurethane foam surface and occurrence of pinholes are important factors.

However, when a typical silicone surfactant, for example, a polyether polydimethylsiloxane copolymer is used, pinholes are likely to be created in the foam or the coating layer, causing penetration of moisture or gas and thus deterioration in physical properties of the foam.

Thus, the surfactant used in the highly flame retardant polyurethane spray foam composition according to the present invention includes a non-silicone surfactant and a silicone surfactant, whereby creation of pinholes in the foam or the coating layer can be prevented and the surface of the foam can be flat, thereby improving quality of the foam.

The additive may further include a catalyst. The catalyst may be present in an amount of, for example, 0.1 parts by weight to 10 parts by weight relative to 100 parts by weight of the resin mixture. If the amount of the catalyst is less than 0.1 parts by weight, the catalyst cannot sufficiently promote reaction between the polyol and the isocyanate compound, whereas, if the amount of the catalyst exceeds 10 parts by weight, the reaction is no longer effectively promoted by the catalyst.

The catalyst serves to promote or delay reaction between the polyol and the isocyanate compound without taking part in polymerization and may be, for example, an amine catalyst, a potassium catalyst, or a tin catalyst, without being limited thereto.

Specifically, the amine catalyst may include at least one selected from the group consisting of dimethylethanolamine (DMEA), dimethylcyclohexylamine (DMCHA), pentamethylene diethylene triamine (PMDETA), and tetramethyl-hexanediamine (TMHDA). The tin catalyst may be used to achieve a faster reaction rate than the amine catalyst or the potassium catalyst.

The additive may further include a flame retardant. The flame retardant may be present in an amount of, for example, 5 parts by weight to 30 parts by weight, relative to 100 parts by weight of the resin mixture. If the amount of the flame retardant is less than 5 parts by weight, the flame retardant cannot provide sufficient flame retardancy, whereas, if the amount of the flame retardant exceeds 30 parts by weight, reactivity between the polyol and the isocyanate compound can be poor due to decrease in relative content of the polyol.

The flame retardant may include at least one selected from the group consisting of phosphorous flame retardants, nitrogen flame retardants, inorganic flame retardants, and halogen flame retardants. Particularly, the flame retardant can suppress side reaction that can occur during a polyurethane-forming reaction between the polyol and the isocyanate compound while providing flame retardancy to foam.

In the highly flame retardant polyurethane spray foam composition according to the present invention, the polyether polyol and the aromatic polyester polyol may be present in amounts of 1 wt % to 10 wt % and 45 wt % to 65 wt %, respectively, per 100 parts by weight of the resin mixture, thereby increasing the density and compressive strength of foam and improving both flame retardancy and workability of the foam while providing reactivity and thermal conductivity.

In addition, in the highly flame retardant polyurethane spray foam composition according to the present invention, the blowing agent may be present in an amount of 10 wt % to 30 wt % per 100 parts by weight of the resin mixture. If the amount of the blowing agent is less than 10 wt %, the amount of generated gas is insignificant, causing reduction in density of polyurethane foam prepared using the composition and thus excessive hardness of the polyurethane foam, whereas, if the amount of the blowing agent exceeds 30 wt %, the amount of generated gas is excessively large, causing the polyurethane foam to have excessively low density and to be excessively soft.

Another embodiment of the present invention relates to highly flame retardant polyurethane spray foam including the highly flame retardant polyurethane spray foam composition as set forth above.

A further embodiment of the present invention relates to a heat insulator including the highly flame retardant polyurethane spray foam as set forth above.

The highly flame retardant polyurethane spray foam may be formed by reacting the isocyanate compound with the resin mixture including the polyether polyol, the aromatic polyester polyol, the blowing agent, and the additives including the flame retardant, the surfactant, and the catalyst.

Polyurethane spray foam is divided into continuously molded foam and intermittently molded foam depending upon manufacturing method. The continuously molded foam is divided into top-opened slab foam and top and bottom-closed sandwich panel foam. The top-opened foam is generally manufactured by free-foaming using a mixture in which a urethane composition is included in a certain amount, and is less affected by the external environment during formation thereof and thus can have a uniform internal structure. In order to be used as a heat insulator, the continuously molded foam may be cut to a certain size, followed by attaching panels, such as plywood, to both sides thereof. Alternatively, the continuously molded foam may be used as a heat insulator without this process.

The intermittently molded foam is manufactured by injection molding a urethane composition into a mold having a predetermined shape, and may be used as a heat insulator for a product having a predetermined structure, such as a refrigerator, a refrigeration container, and a refrigeration panel. The intermittently molded foam manufactured by injection molding does not require post-treatment such as cutting and thus can reduce material loss, thereby having high productivity.

Polyurethane foam may be prepared by a one-shot method, a prepolymer method, a spray method, or other well-known methods depending upon the method of reacting raw materials with one another.

In the one-shot method, all of raw materials such as the isocyanate component and the polyol are mixed and reacted at the same time. The one-shot method is simple and easy to perform, but has a problem in that since reactions between the raw materials occur all at once, it is difficult to regulate a reaction rate and cracks are likely to be generated in the foam due to a large amount of reaction heat.

In the prepolymer method, after the polyol is reacted with the isocyanate in advance, the resulting material is further reacted with the other raw materials. The prepolymer method is advantageous in that reactions occur relatively smoothly with a high reaction rate and rise in viscosity of the foam due to the reactions slows down, such that even a complex structure can be thoroughly filled with the foam, but requires prolonged processing time, causing increase in unit cost.

In the spray method, the raw materials including the isocyanate, the polyol, and the like are mixed together, followed by spraying the mixture through a nozzle using high-pressure air. In the spray method, irregular foam can be formed on a surface of a target object in a few seconds, thereby providing high in-situ workability.

A foaming machine used to manufacture the polyurethane foam may be any high-pressure or low-pressure foaming machine commonly used in the art. In addition, foaming conditions such as temperature of a stock solution and discharge amount may vary depending upon the type of foaming machine.

If the viscosity of a stock solution of the composition is high, there can be a difference in physical properties, such as strength and density, between parts of the foam. Thus, the stock solution of the composition preferably has a viscosity of 1800 or less at 25° C.

The foam manufacturing methods as described above may be applied to manufacture of a heat insulator through spraying or in-situ foaming, as well as to manufacture continuous sandwich panels and intermittent panels.

Next, the present invention will be described in more detail with reference to examples. However, it should be noted that these examples are provided for illustration only and should not be construed in any way as limiting the invention.

In addition, descriptions of details apparent to those skilled in the art will be omitted for clarity.

### EXAMPLE

### Examples 1 to 3

A mixture of a polyether polyol and an aromatic polyester polyol was used as polyol. After a blowing agent, a flame retardant, a surfactant, and a catalyst were mixed with the polyol to prepare a resin mixture, an isocyanate compound was stirred into the resin mixture, thereby preparing a polyurethane spray foam composition, followed by a foaming process.

Polyurethane spray foam was prepared using a spray foaming machine under the following conditions: Storage temperature of 40° C. (the polyurethane spray foam composition), hose temperature of 40° C., operating pressure of 1,000 psi, and demold time of 30 minutes.

Details of each polyurethane spray foam composition prepared in Examples 1 to 3 are shown in Table 1.

### Comparative Examples 1 to 3

A polyurethane spray foam composition was prepared in the same manner as in Examples 1 to 3 except that the amount of the polyol was changed. Details of each composition prepared in Comparative Examples 1 to 3 are shown in Table 1.

TABLE 1

| | | | | Comp. | Comp. | Comp. |
|---|---|---|---|---|---|---|
| Item | Example 1 | Example 2 | Example 3 | Example 1 | Example 2 | Example 3 |
| Polyether polyol 1 | 5 | | | 40 | | |
| (parts by weight) | | | | | | |
| Polyether polyol 2 | | 5 | | | 40 | |
| (parts by weight) | | | | | | |
| Polyether polyol 3 | | | 5 | | | 40 |
| (parts by weight) | | | | | | |
| Aromatic polyester polyol | 55 | 55 | 55 | 20 | 20 | 20 |
| (parts by weight) | | | | | | |
| Flame retardant | 15 | 15 | 15 | 15 | 15 | 15 |
| (parts by weight) | | | | | | |
| Surfactant | 0.5 | 0.5 | 0.5 | 0.5 | 0.5 | 0.5 |
| (parts by weight) | | | | | | |
| Catalyst (parts by weight) | 4.5 | 4.5 | 4.5 | 4.5 | 4.5 | 4.5 |
| Blowing agent | 20 | 20 | 20 | 20 | 20 | 20 |
| (parts by weight) | | | | | | |
| Total (parts by weight) | 100 | 100 | 100 | 100 | 100 | 100 |
| P-MDI (parts by weight) | 100 | 100 | 100 | 100 | 100 | 100 |

| | |
|---|---|
| Polyether polyol 1 | Polyether polyol, KONIX HR-380P produced by KPX Chemical Co., ltd. |
| | (initiator: sucrose/glycerine, 5 functional groups) |
| Polyether polyol 2 | Polyether polyol, KONIX KR-403 produced by KPX Chemical Co., ltd. |
| | (initiator: TDA, 4 functional groups) |
| Polyether polyol 3 | Polyether polyol, KONIX KFT-120 produced by KPX Chemical Co., ltd. |
| | (initiator: EDA, 4 functional groups) |
| Aromatic polyester polyol | Aromatic polyester polyol, AK-POL-7001 produced by AEKYUNG |
| | PETROCHEMICAL Co., ltd. |
| | (average hydroxyl value: 300 mgKOH/g) |
| Flame retardant | Phosphorous flame retardant, TEP produced by YOKE |
| Blowing agent | Blowing agent, SOLKANE ® 365/227 Blends produced by SOVAY |
| Surfactant | Surfactant B-8462 produced by Evonik |

### Experimental Example 1—Evaluation of Properties of Polyurethane Spray Foam Different in Polyol Content

The polyurethane spray foams prepared in Examples 1 to 3 and Comparative Examples 1 to 3 were evaluated as to reactivity, free foam density, thermal conductivity, compressive strength, flame retardancy, and workability. Results are shown in Table 2.

TABLE 2

| | | | | | | Comp. | Comp. | Comp. |
|---|---|---|---|---|---|---|---|---|
| | | | Example | Example | Example | Example | Example | Example |
| Item | | Unit | 1 | 2 | 3 | 1 | 2 | 3 |
| Reactivity | CT/TFT | sec | 3/14 | 3/11 | 3/13 | 4/21 | 3/8 | 3/9 |
| | TFT-CT | | 11 | 8 | 10 | 16 | 5 | 6 |

| | | | | | | | |
|---|---|---|---|---|---|---|---|
| Free foam density | kg/m³ | 35 | 35 | 34 | 32 | 32 | 33 |
| Thermal conductivity | W/mK | 0.021 | 0.021 | 0.021 | 0.021 | 0.020 | 0.022 |
| (20° C.) | | | | | | | |
| Compressive strength | N/mm² | 0.26 | 0.25 | 0.25 | 0.21 | 0.22 | 0.22 |
| Flame retardancy | cm | 8 | 7 | 8 | 11 | 12 | 12 |
| Workability | — | 3 | 5 | 3 | 2 | 3 | 3 |

(1) Reactivity (CT/TFT)

After a curing agent was mixed with each of the polyurethane spray foam compositions, the time it took for a stock solution to turn creamy, that is, foaming to start, was measured and then recorded as ‘cream time (CT)’.

In addition, the time it took for a surface of the polyurethane spray foam to lose tack was measured and recorded as ‘tack free time (TFT)’.

(2) Free Foam Density

With disturbance from the outside minimized, each of the polyurethane spray foam compositions was foamed, thereby preparing foam, followed by measurement of the density of the foam. Specifically, the foam was prepared using a coverless cup, box, or plastic bag without being over-packed and then cut to a certain size, followed by measurement of the volume and weight of the foam, thereby calculating the density. Here, the density was defined as the weight per unit volume of the polyurethane spray foam.

(3) Thermal Conductivity

Thermal conductivity was measured in accordance with KS M-3809, followed by converting the measurements into adiabatic values (W/mK).

(4) Compressive Strength

The prepared polyurethane spray foam was compressed to 90% an initial height thereof in a direction perpendicular to or parallel to the foaming direction to measure the strength of the foam, followed by converting the measurements into N/mm².

(5) Flame Retardancy

Surface evaluation was conducted in accordance with DIN 4102/B2 (fire resistance test, German industrial standard) to measure carbonized length.

(6) Workability

Workability was determined based on the range of reactivity between the main components and a curing agent in which normally formed polyurethane spray foam does not flow and can be adhered to an adherend. Specific criteria are shown in Table 3.

TABLE 3

| Workability evaluation | | | | | | |
|---|---|---|---|---|---|---|
| criteria | | 5 | 4 | 3 | 2 | 1 |
| Reactivity | CT (sec) | 2~3 | >3 | >3 | >3 | >3 |
| | TFT (sec) | 10~11 | 7~9, | <7, | <7, | >20, <7 |
| | | | 12~13 | 14~16 | 17~20 | |

| | | | | | |
|---|---|---|---|---|---|
| Post-foaming | x | x | ∘ | ∘ | ∘ |
| Bubbling | x | x | x | ∘ | ∘ |

Post-foaming: ‘post-foaming’ is a phenomenon in which foaming continues even after completion of polyurethane spraying, and causes deterioration in in-situ workability.
Bubbling: ‘bubbling’ is a phenomenon in which bubbles having a size of about 10 cm to 40 cm are generated during polyurethane spraying, and causes deterioration in in-situ workability.

As shown in Table 2, it can be seen that the polyurethane spray foam prepared using the composition according to the present invention including 45 wt % to 65 wt % of the aromatic polyester polyol having an average hydroxyl value of 250 mgKOH/g to 380 mgKOH/g and 1 wt % to 10 wt % of the polyether polyol per 100 parts by weight of the resin mixture, had good properties in terms of free foam density, compressive strength, flame retardancy and workability, while securing reactivity and thermal conductivity.

### Examples 4 to 6

A polyurethane spray foam composition was prepared in the same manner as in Examples 1 to 3 except that the amount of the polyol and the average hydroxyl value of the aromatic polyester polyol were changed.

Details of each polyurethane spray foam composition prepared in Examples 4 to 6 are shown in Table. 4.

### Comparative Examples 4 to 7

A polyurethane spray foam composition was prepared in the same manner as in Examples 4 to 6 except that the amount of the polyol and the average hydroxyl value of the aromatic polyester polyol were changed. Details of each polyurethane spray foam composition prepared in Comparative Examples 4 to 7 are shown in Table. 4.

TABLE 4

| | | | | Comp. | Comp. | Comp. | Comp. |
|---|---|---|---|---|---|---|---|
| | Example | Example | Example | Example | Example | Example | Example |
| Item | 4 | 5 | 6 | 4 | 5 | 6 | 7 |
| Aromatic polyester polyol 1 | | | | 50 | | 30 | |
| (parts by weight) | | | | | | | |
| Aromatic polyester polyol 2 | 50 | | | | | | |
| (parts by weight) | | | | | | | |
| Aromatic polyester polyol 3 | | 50 | | | | | |
| (parts by weight) | | | | | | | |
| Aromatic polyester polyol 4 | | | 50 | | | | |
| (parts by weight) | | | | | | | |
| Aromatic polyester polyol 5 | | | | | 50 | | 30 |
| (parts by weight) | | | | | | | |
| Polyether polyol (parts by | 10 | 10 | 10 | 10 | 10 | 30 | 30 |
| weight) | | | | | | | |
| Flame retardant (parts by weight) | 15 | 15 | 15 | 15 | 15 | 15 | 15 |
| Surfactant (parts by weight) | 0.5 | 0.5 | 0.5 | 0.5 | 0.5 | 0.5 | 0.5 |
| Catalyst (parts by weight) | 4.5 | 4.5 | 4.5 | 4.5 | 4.5 | 4.5 | 4.5 |
| Blowing agent (parts by weight) | 20 | 20 | 20 | 20 | 20 | 20 | 20 |
| Total | 100 | 100 | 100 | 100 | 100 | 100 | 100 |
| P-MDI | 100 | 100 | 100 | 100 | 100 | 100 | 100 |

| | |
|---|---|
| Aromatic polyester polyol 1 | Aromatic polyester polyol, WJESPOL-3200 produced by Woojo Chemical |
| | Co., Ltd. (average hydroxyl value: 200 mgKOH/g) |
| Aromatic polyester polyol 2 | Aromatic polyester polyol, PGE-2 produced by Dongsung Chemical Co., Ltd. |
| | (average hydroxyl value: 250 mgKOH/g) |
| Aromatic polyester polyol 3 | Aromatic polyester polyol, AK-POL-7001 produced by AEKYUNG |
| | PETROCHEMICAL Co., ltd. |
| | (average hydroxyl value: 300 mgKOH/g) |
| Aromatic polyester polyol 4 | Aromatic polyester polyol, PGE-4 produced by Dongsung Chemical Co., Ltd. |
| | (average hydroxyl value: 380 mgKOH/g) |
| Aromatic polyester polyol 5 | Aromatic polyester polyol, PGE-5 produced by Dongsung Chemical Co., Ltd. |
| | (average hydroxyl value: 400 mgKOH/g) |
| Polyether polyol | Polyether polyol, KONIX HR-380P produced by KPX Chemical Co., ltd. |
| | (initiator: sucrose/glycerine, 5 functional groups) |
| Flame retardant | Phosphorous flame retardant, TEP produced by YOKE |
| Blowing agent | Blowing agent, SOLKANE ® 365/227 Blends produced by SOVAY |
| Surfactant | Surfactant B-8462 produced by Evonik |

### Experimental Example 2—Evaluation of Properties of Polyurethane Spray Foams Having Different Hydroxyl Values of an Aromatic Polyester Polyol

The polyurethane spray foams prepared in Examples 4 to 6 and Comparative Examples 4 to 7 were evaluated as to reactivity, free foam density, thermal conductivity, compressive strength, flame retardancy, and workability in the same manner as in Experimental Example 1. Results are shown in Table 5.

TABLE 5

| | | | | | | Comp. | Comp. | Comp. | Comp. |
|---|---|---|---|---|---|---|---|---|---|
| | | | Example | Example | Example | Example | Example | Example | Example |
| Item | | Unit | 4 | 5 | 6 | 4 | 5 | 6 | 7 |
| Reactivity | CT/TFT | sec | 3/13 | 3/11 | 3/9 | 3/15 | 3/9 | 4/21 | 4/23 |
| | TFT-CT | | 10 | 8 | 6 | 12 | 6 | 17 | 19 |

| | | | | | | | | |
|---|---|---|---|---|---|---|---|---|
| Free foam density | kg/m³ | 37 | 35 | 35 | 38 | 33 | 34 | 31 |
| Thermal conductivity | W/mK | 0.022 | 0.021 | 0.021 | 0.022 | 0.021 | 0.021 | 0.021 |
| Compressive strength | N/mm² | 0.26 | 0.25 | 0.25 | 0.27 | 0.22 | 0.23 | 0.21 |
| Flame retardancy | cm | 6 | 7 | 7 | 6 | 10 | 12 | 13 |
| Workability | — | 5 | 5 | 4 | 2 | 4 | 1 | 1 |

As shown in Table 5, it can be seen that the polyurethane spray foam according to the present invention using the aromatic polyester polyol having an average hydroxyl value of 250 mgKOH/g to 380 mgKOH/g could secure both flame retardancy and workability without deterioration in other properties such as thermal conductivity and compressive strength.

### Examples 7 to 8

In Example 7, a polyurethane spray foam composition was prepared in the same manner as in Example 1 except that a different blowing agent was used. In Example 8, a polyurethane spray foam composition was prepared in the same manner as in Example 2 except that a different blowing agent was used.

Details of the different blowing agents are shown in Table 6.

### Comparative Examples 8 to 9

In Comparative Example 8, a polyurethane spray foam composition was prepared in the same manner as in Example 7 except that a different blowing agent was used. In Comparative Example 9, a polyurethane spray foam composition was prepared in the same manner as in Example 8 except that a different blowing agent was used.

Details of the different blowing agents are shown in Table 6.

TABLE 6

| | | | Thermal | Boiling |
|---|---|---|---|---|
| | | | conductivity | point |
| Blowing agent | ODP | GWP | [Gas, mw/mK, 25° C.] | (° C.) |
| HFC-245fa | 0 | 1030 | 12.7 | 15 |
| HFC-365/227 (93:7) | 0 | 1030 | 10.7 | 30 |

HFC-245fa: 1,1,1,3,3-pentafluoropropane (Honeywell)
HFC-365/227: 1,1,1,3,3-pentafluorobutane/1,1,1,2,3,3,3-Heptafluoropropane (SOLVAY)

### Experimental Example 3—Evaluation of Adhesive Strength of Polyurethane Spray Foam Using at Least Two Blowing Agents

Adhesive strength of the polyurethane spray foams prepared in Examples 7 to 8 and Comparative Examples 8 to 9 was measured under the following conditions, followed by converting measurement values into N/mm². Results are shown in FIG. 7.

<Adhesive Strength Measurement Method and Measurement Conditions>

Test method: HS K-6401

Test instrument: Universal testing machine (Instron model 5565)

Sample size (T×W×L): Predetermined value (mm)×25.4 mm×150 mm

Test rate: 200/min

Test direction: Machine direction (MD)

TABLE 7

| | Amount (wt %, based on total | | | |
|---|---|---|---|---|
| | weight of resin mixture) | | | |
| | | | Comparative | Comparative |
| Blowing agent | Example 7 | Example 8 | Example 8 | Example 9 |
| HFC-245fa | 10 | 20 | 30 | |
| HFC-365/227 | 20 | 10 | | 30 |
| Adhesive strength | 0.41 | 0.53 | 0.15 | 0.12 |
| [N/mm2] | | | | |

As shown in Table 7, it can be seen that the polyurethane spray foam according to the present invention prepared using at least two blowing agents had better adhesive strength than the polyurethane spray foam of Comparative Examples 8 and 9 prepared using one blowing agent.

Since application of spray-type polyurethane foam products is performed without using a separate adhesive, the quality of the spray-type polyurethane foam products depends on adhesion to an adherend or adhesion therebetween. Thus, the polyurethane spray foam according to the present invention is useful as a material for a building panel, a panel for a refrigeration warehouse, and an insulator for an LNG, LEG, or LPG tank.

### Examples 9 to 10

In Example 9, a polyurethane spray foam composition was prepared in the same manner as in Example 1 except that a different surfactant was used. In Example 10, a polyurethane spray foam composition was prepared in the same manner as in Example 2 except that a different surfactant was used.

Details of the different surfactants are shown in Table 8.

### Comparative Examples 10 to 11

In Comparative Example 10, a polyurethane spray foam composition was prepared in the same manner as in Example 9 except that a different surfactant was used. In Example 11, a polyurethane spray foam composition was prepared in the same manner as in Example 10 except that a different surfactant was used.

Details of the different surfactants are shown in Table 8.

TABLE 8

| Type | | Manufacturer |
|---|---|---|
| Silicon surfactant | B-8462 | Evonik |
| | B-8404 | Evonik |
| Non-silicon surfactant | P-9800 | ELA |
| | LK-443 | Air product |

### Experimental Example 4—Evaluation of Qualities of Polyurethane Spray Foam and Heat Insulator Using Both Silicone and Non-Silicone Surfactants

After a heat insulator obtained by coating a polymer onto the polyurethane spray foam prepared in Examples 9 to 10 and Comparative Examples 10 to 11 was formed on a surface of an adherend, presence of pinholes on a surface of the coating layer or the polyurethane spray foam and surface roughness were observed with the naked eye. Results are shown in Table 9.

TABLE 9

| | Amount (wt %, based on total | | | |
|---|---|---|---|---|
| | weight of resin mixture) | | | |
| | | | Comparative | Comparative |
| Surfactant | Example 9 | Example 10 | Example 10 | Example 11 |
| B-8462 | 0.4 | 0.6 | 1 | — |
| P-9800 | 0.6 | 0.4 | — | 1 |
| Pinhole on | x | x | x | ∘ |
| coating layer | | | | |
| Pinhole on | x | x | ∘ | x |
| surface of foam | | | | |
| Surface roughness | Flat | Flat | Flat | Rough |

As shown in Table 9, it can be seen that the polyurethane spray foam and heat insulator according to the present invention prepared using both silicone and non-silicone surfactants did not have pinholes on the surface thereof, unlike those of Comparative Examples prepared using any one of silicone and non-silicone surfactants.

In addition, it can be seen that the heat insulator of Comparative Example 10 prepared using a silicone surfactant alone had pinholes on the surface of the coating layer or the foam and thus could have poor insulation performance due to penetration of moisture or gas. Further, for the heat insulator of Comparative Example 11 prepared using a non-silicone surfactant alone, it was apparent to the naked eye that the surface of the heat insulator was very rough, causing deterioration in product quality and insulation performance.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention should be defined by the appended claims and equivalents thereof.

What is claimed is:

1. A highly flame retardant polyurethane spray foam composition, comprising:
100 parts by weight to 200 parts by weight an isocyanate compound relative to 100 parts by weight of a resin mixture comprising 46 wt % to 75 wt % of a polyol, 10 wt % to 30 wt % of a blowing agent, and 5 wt % to 30 wt % of an additive,
wherein the polyol comprises 1 wt % to 10 wt % of a polyether polyol and 45 wt % to 65 wt % of an aromatic polyester polyol, the aromatic polyester polyol having an average hydroxyl value of 250 mgKOH/g to 380 mgKOH/g.

2. The highly flame retardant polyurethane spray foam composition according to claim 1, wherein the polyether polyol is polymerized using an initiator having 3 to 7 hydroxyl groups per molecule.

3. The highly flame retardant polyurethane spray foam composition according to claim 2, wherein the initiator comprises at least one selected from the group consisting of sucrose, glycerine, toluenediamine, and ethylenediamine each having 3 to 6 hydroxyl groups per molecule.

4. The highly flame retardant polyurethane spray foam composition according to claim 2, wherein the initiator has a number average molecular weight of 100 g/mol to 2,000 g/mol.

5. The highly flame retardant polyurethane spray foam composition according to claim 1, wherein the aromatic polyester polyol comprises a compound prepared by polymerizing at least one selected from the group consisting of phthalic anhydride, terephthalic acid, adipic acid, ethylene glycol, and diethylene glycol.

6. The highly flame retardant polyurethane spray foam composition according to claim 1, wherein the blowing agent comprises a mixture or compound comprising at least two compounds, the at least two compounds comprising at least one selected from the group consisting of fluorine compounds having different boiling points and C₄ to C₁₀ cycloalkanes.

7. The highly flame retardant polyurethane spray foam composition according to claim 6, wherein the fluorine compounds comprise at least one selected from the group consisting of hydrochlorofluorocarbon (HCFC) compounds, hydrofluorocarbon (HFC) compounds, and hydrochlorofluoroolefin (HCFO) compounds.

8. The highly flame retardant polyurethane spray foam composition according to claim 7, wherein the hydrochlorofluorocarbon (HCFC) compounds comprise 1,1-dichloro-1-fluoroethane.

9. The highly flame retardant polyurethane spray foam composition according to claim 7, wherein the hydrofluorocarbon (HFC) compounds comprise at least one selected from the group consisting of 1,1,1,3,3-pentafluoropropane, 1,1,1,3,3-pentafluorobutane, and 1,1,1,2,3,3,3-heptafluoropropane.

10. The highly flame retardant polyurethane spray foam composition according to claim 7, wherein the hydrochlorofluoroolefin (HCFO) compounds comprise 1-chloro-3,3,3-trifluoropropylene.

11. The highly flame retardant polyurethane spray foam composition according to claim 1, wherein the additive comprises a non-silicone surfactant and a silicone surfactant.

12. The highly flame retardant polyurethane spray foam composition according to claim 1, wherein the non-silicone surfactant comprises alkoxy alcohol.

13. Highly flame retardant polyurethane spray foam comprising highly flame retardant polyurethane spray foam composition comprising:
100 parts by weight to 200 parts by weight an isocyanate compound relative to 100 parts by weight of a resin mixture comprising 46 wt % to 75 wt % of a polyol, 10 wt % to 30 wt % of a blowing agent, and 5 wt % to 30 wt % of an additive,
wherein the polyol comprises 1 wt % to 10 wt % of a polyether polyol and 45 wt % to 65 wt % of an aromatic polyester polyol, the aromatic polyester polyol having an average hydroxyl value of 250 mgKOH/g to 380 mgKOH/g.

14. A heat insulator comprising highly flame retardant polyurethane spray foam, the highly flame retardant polyurethane spray foam comprising highly flame retardant polyurethane spray foam composition comprising.
100 parts by weight to 200 parts by weight an isocyanate compound relative to 100 parts by weight of a resin mixture comprising 46 wt % to 75 wt % of a polyol, 10 wt % to 30 wt % of a blowing agent, and 5 wt % to 30 wt % of an additive,
wherein the polyol comprises 1 wt % to 10 wt % of a polyether polyol and 45 wt % to 65 wt % of an aromatic polyester polyol, the aromatic polyester polyol having an average hydroxyl value of 250 mgKOH/g to 380 mgKOH/g.
